(19) United States
(12) Patent Application Publication
(10) Pub. No.: US 2007/0176784 A1
(43) Pub. Date: Aug. 2, 2007

(54) Hazard marker

(75) Inventors: Dallas Fautin, Henderson, NV (US); Douglas L. Beekman, Henderson, NV (US)

Correspondence Address: GREENBERG TRAURIG, 3773 HOWARD HUGHES PARKWAY, SUITE 500 NORTH, LAS VEGAS, NV, 89169, US

(73) Assignee: TurboFlare USA, LLC

(21) Appl. No.: 11/344,686

(22) Filed: Feb. 1, 2006

(51) Int. Cl. G08B 21/00; G08B 3/00; G08G 1/095

(52) U.S. Cl. 340/686.1; 340/691.6; 340/908

(57) ABSTRACT

A hazard marker is disclosed. The hazard marker utilizes a series of illumination devices (e.g., LEDs) positioned to generate a highly visible light pattern. The hazard marker includes a motion detector and transmitter to alert users that the hazard marker has been moved in a pre-established manner (e.g., thirty degrees off horizontal). As a result of being moved in the pre-established manner, a signal transmitted by the hazard marker triggers an alarm in a receiver held by a user (e.g., police officer). The alarm alerts the user that a safe zone defined by a series of hazard markers has been breached or a hazard marker is being physically moved and possibly stolen.

### FIELD OF THE INVENTION

The embodiments of the present invention relate to hazard markers designed to provide illuminated warnings to vehicle traffic on highways, roads, streets and the like. More particularly, the embodiments relate to a mobile illumination hazard marker having numerous safety features for both approaching traffic and users.

### BACKGROUND

Traffic accidents, stalled vehicles and similar highway incidents are very dangerous. In fact, many times traffic accidents lead to other accidents and stalled vehicles become the cause of an accident. In the past, road flares have been utilized to warn oncoming traffic of a traffic incident that requires additional caution. Unfortunately, road flares are dangerous for users and cause damage to the road, start fires and can be left behind as litter.

Attempts have been made to overcome the drawbacks associated with road flares. For example, U.S. Pat. No. 6,486,797 (“the '797 Patent”) discloses a “Turbo Flare Hazard Marker” that utilizes a series of blinking or flashing LEDs to warn oncoming traffic. Applicant as a licensee of the '797 Patent hereby incorporates by reference the '797 Patent and its complete disclosure for all purposes. Nonetheless, the hazard marker of the '797 Patent, as described herein, can be improved.

Thus, there continues to be a need for an improved hazard marker for providing warning for oncoming traffic and providing maximum safety for its users.

### SUMMARY

Accordingly, a first apparatus embodiment of the present invention is a hazard marker comprising a housing having a transparent section; a series of illumination devices for creating a pre-established light pattern wherein said light pattern is visible through said transparent section; a motion detector operable to alert users that the hazard marker has been moved in a pre-established manner; and a transmitter in communication with said motion detector and operable to transmit a signal in response to the hazard marker being moved in the pre-established manner.

A first method embodiment of the present invention comprises generating a light pattern visible through a hazard marker housing; generating a signal in response to the hazard marker housing being moved in a pre-established manner; and sending said signal to a receiver to alert a user that the hazard marker has been moved in the pre-established manner.

The motion detector and transmitter operate to send an alarm signal to one or more receivers operated by one or more users (e.g., police officers). The signal triggers an alarm that alerts the user that one of the hazard markers has been moved or otherwise disturbed. Such an alarm allows users to avoid injury that can be caused by a vehicle inadvertently entering an accident zone defined by a series of hazard markers. The motion detector also permits users to identify theft of the hazard markers as it occurs.

Other variations, embodiments and features of the present invention will become evident from the following detailed description, drawings and claims.

### BRIEF DESCRIPTION OF THE DRAWINGS

FIG. 1 illustrates a perspective view of a hazard marker according to one embodiment of the present invention;

FIG. 2 illustrates a top view of the hazard marker according to one embodiment of the present invention;

FIGS. 3 and 4 illustrate an upper section and lower section disjoined from one another;

FIG. 5 illustrates a circuit diagram of one embodiment of the present invention;

FIG. 6 illustrates a receiver of one embodiment of the present invention;

FIG. 7 illustrates a block diagram of internal components of the receiver; and

FIG. 8 illustrates an exploded view of an optional reflective flag and connector means and FIG. 8A illustrates a top view of the connector means.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

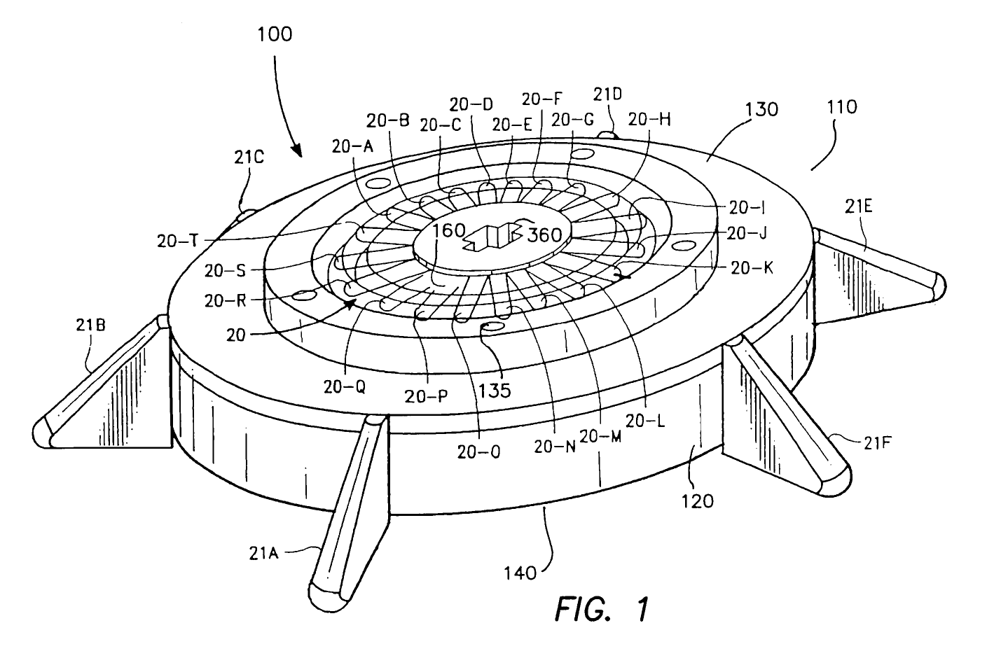

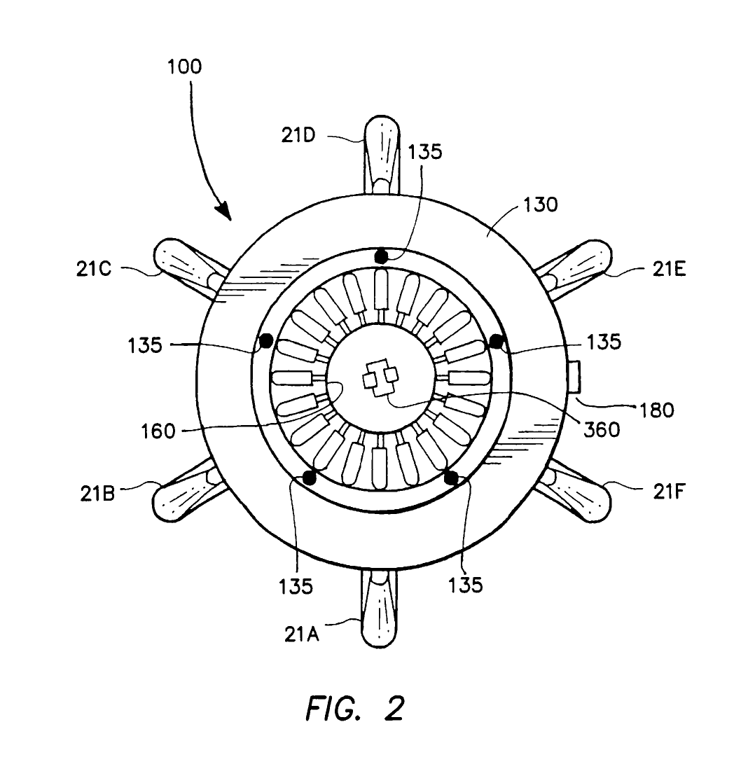

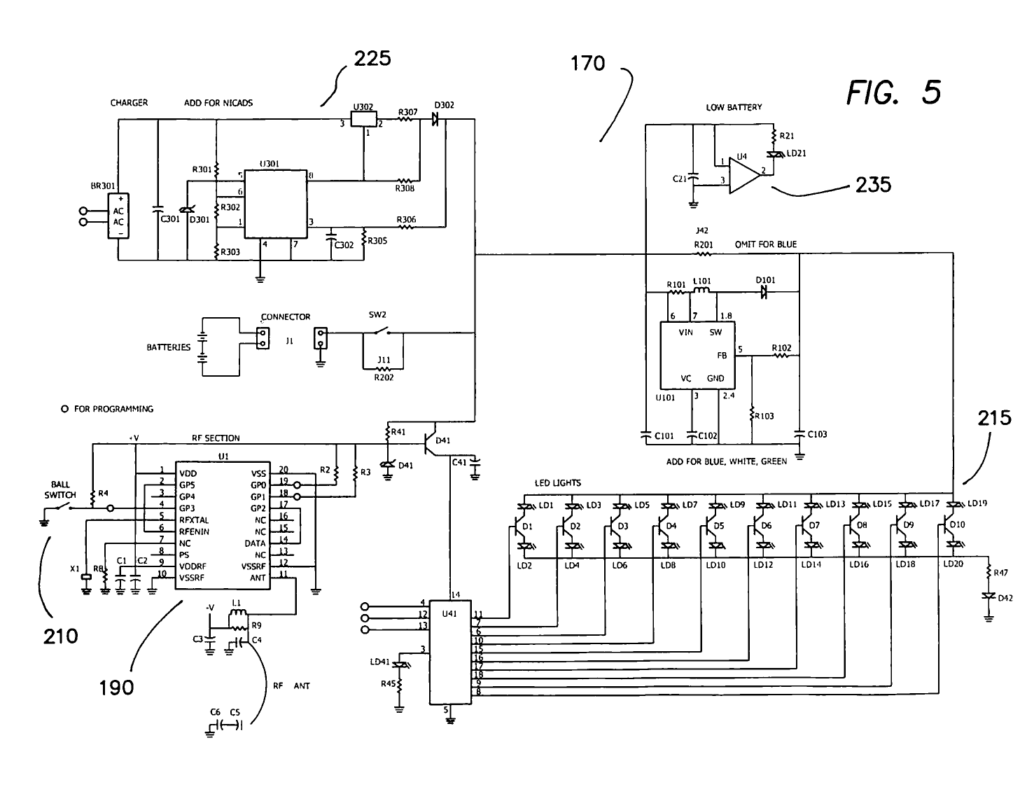

Reference is now made to the figures wherein like parts are referred to by like numerals throughout. FIGS. 1-4 show a hazard marker according to a first embodiment of the present invention and generally denoted by reference numeral 100. The hazard marker 100 comprises a circular housing 110 having an opaque lower section 120 defining a cavity 125 (FIG. 4) and a transparent upper section 130. The lower section 120 and upper section 130 are held together with a peg and wing nut as described in more detail below. The housing 110 is designed to protect the operational components of the hazard marker 100 and to withstand outside forces (e.g., being run over by a vehicle). Accordingly, the hazard marker 100 may be fabricated of heavy duty plastic, hardened rubber, composites, or metal alloys.

The cavity 125 is suitable for containing rechargeable batteries 145-1 through 145-5 or multiple conventional non-rechargeable batteries held in place on an underside of the upper section 130. As shown, the rechargeable batteries 145-1 through 145-5 (e.g., NiCad batteries) are connected in series by conductive ribbon 155. An anode of one battery 145-1 and a cathode of another battery 145-2 are connected through wires 175, 205, respectively, to a plug 195 which mates with a socket 185. A pair of wires 165 connects the socket 185 to the circuit board 160 such that the batteries 145-1 through 145-5 provide a voltage to the circuit board 160. The batteries 145-1 through 145-5 may be charged by an adapter that plugs into a wall outlet at one end and the hazard marker 100 at the other end. A hazard marker adapter opening communicates with the batteries 145-1 through 145-5 so that they receive the necessary charge.

While the figures show legs 21A-21E, the embodiments of the present invention may or may not utilize legs. A legless design facilitates a simpler and more efficient manufacturing process. With such an embodiment, a bottom surface 140 of the hazard marker device 100 may be coated with a tacky or non-slide surface for maintaining a position of the hazard marker 100 upon placement on a road or similar highway surface.

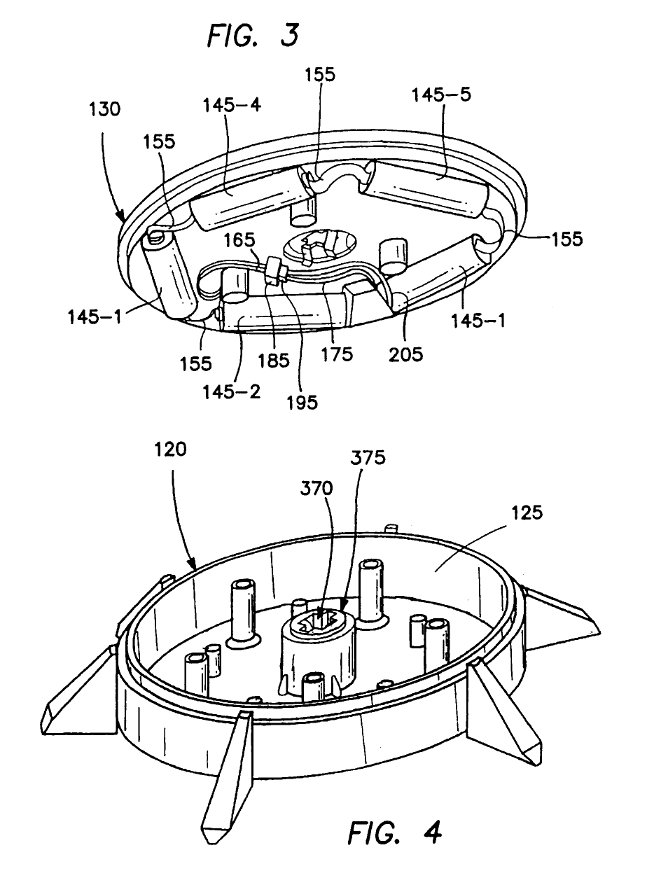

The operational components of the hazard marker 100 include a series of illumination devices, ideally LEDs 20-A through 20-T, a circuit board 160 supporting an integrated circuit 170 (FIG. 3) for, among other reasons as set forth below, to drive the LEDs 20A-20T. The circuit board 160 is attached to an underside of the upper section 130 by means of rivets 135 or similar connector means. A trade name or similar source identifying information can be printed on an upper surface of the circuit board 160 such that the hazard marker 100 may be branded. The trade name is then visible through the transparent upper section 130. The LEDs 20A-20T are arranged in a circular pattern on the circuit board 160 and may be individually or jointly driven to create any number of distinct lighting patterns. For example, the LEDs 20A-20T may be illuminated in series to create a rotational effect, all at once in a flashing manner, all on for a pre-established duration or in some other manner to create any number of countless lighting patterns. The lighting patterns may be controlled with a positional switch on the housing 110 (not shown) or may be programmed into a chip driving the LEDs 20A-20T. Based on the arrangement of the LEDs 20A-20T, their light passes through the transparent upper section 130. It is also conceivable that the upper section 130 may be primarily opaque but include only a transparent portion, in the form of a ring, to allow the light from the LEDs 20A-20T to pass therethrough.

One or more hazard markers 100 can be placed on a road or highway to warn oncoming traffic that an accident or other incident has occurred thereby requiring additional precaution on the part of the oncoming traffic. Such use eliminates the need for road flares and their associated drawbacks. An on-off switch or button 180 positioned on a top, bottom or side surface of the hazard marker 100 may be used to control power to the hazard marker 100. Power is ideally provided by batteries 145-1 through 145-5 but also may be generated using other means including solar means. With a solar embodiment, one or more solar panels (not shown) are incorporated on the upper surface 130 or side surface of the hazard marker 100. The solar panels facilitate the generation of power from the sun's rays. The generated power is then stored for use during the night.

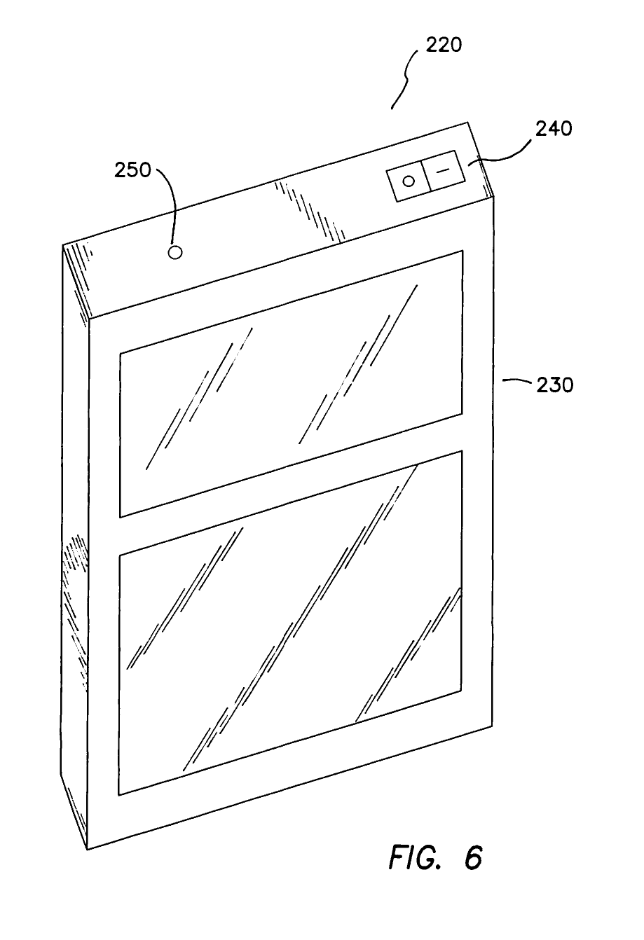

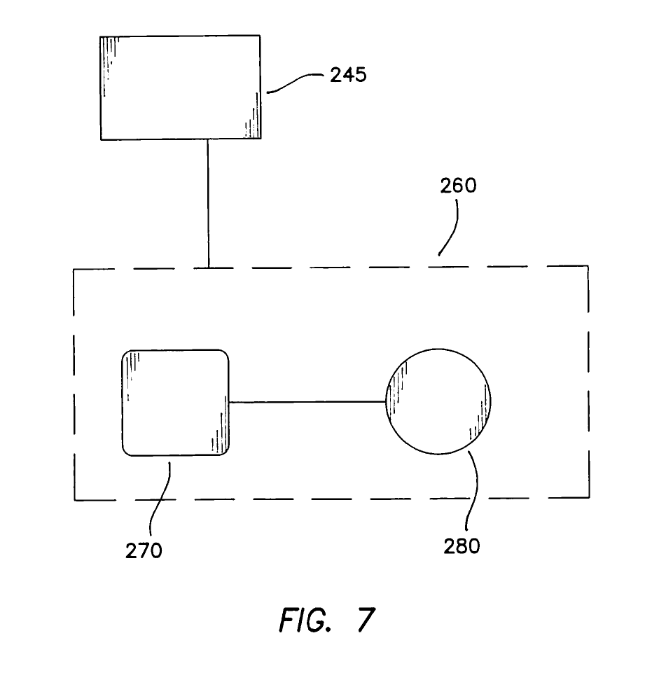

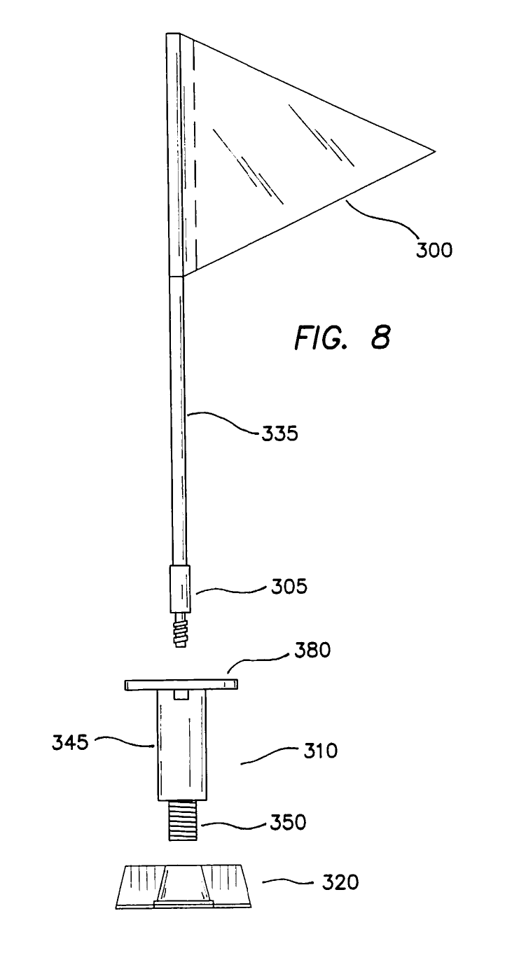

One drawback with hazard markers, like the device disclosed in the '727 Patent, is that they can be moved intentionally or inadvertently, without warning, thereby reducing their effectiveness, causing safety concerns and/or providing an opportunity for theft. As shown in FIG. 5, the integrated circuit 170 includes an RF chip 190, having a low power transmitter, linked to a ball switch 210 mounted to the circuit board 160. The ball switch 210 reacts to certain movements of the hazard marker 100. For example, the ball switch 210 may be set to close in response to the hazard marker 100 being moved more than 30° off horizontal or level. Closing the ball switch 210 triggers the RF chip 190 to transmit a signal having a particular address and code for receipt by a receiver 220 (FIGS. 6-7) in the possession of a hazard marker 100 user. The circuit 170 also includes a chip and corresponding connectors for driving the LEDs 215, a battery charger circuit 225 and a low battery warning circuit 235.

Upon receiving and verifying the signal, a light 230 and/or audible alarm is generated by the receiver 220 to alert the user that the hazard marker 100 has been moved beyond the set threshold position. Activation of the alarm can be limited to specific time duration (e.g., 20 seconds). The alarm notifies the user that one or more of the hazard markers 100 has been moved. Movement of the hazard markers 100 may signify that a vehicle has breached an accident zone defined by one or more hazard markers 100 thereby creating a dangerous situation for persons within the accident zone. That is, a vehicle passing over the hazard marker 100 will disturb the hazard marker 100 causing the signal to be sent providing the user and others providing a critical warning. The alarm may also signify that a hazard marker 100 is being stolen or otherwise removed improperly from its position.

FIG. 6 shows the receiver 220. The receiver 220 includes a housing 230, on-off toggle switch 240 and on-off light 250. As shown in FIG. 7, the housing 230 contains a battery 245 (e.g., 9 volt battery), integrated receiver circuit 260, including an antenna 270 designed to receive the signal sent by the hazard marker transmitter, and a connected speaker 280 for providing an audible alarm to notify the user that the hazard marker 100 has been moved beyond a pre-established threshold position. Such advance notice saves lives and further prevents theft of the hazard markers. Since the speaker 280 of the receiver 220 creates the alarm, a thief will be unaware that his or her actions have been uncovered and therefore the thief will likely be caught off guard and ideally captured in the criminal act. Ideally, the receiver 220 is able to receive hazard marker signals from a distance of at least 100 feet.

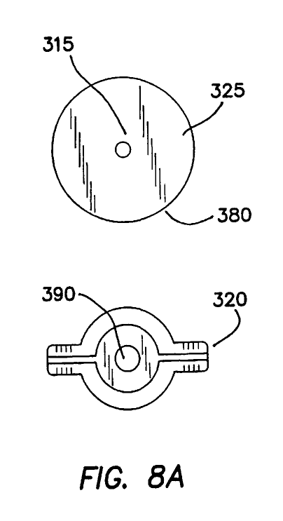

FIGS. 8 and 8A show a reflective flag 300, and a peg 310 and wing nut 320 that may be used to connect the flag 300 to the hazard marker 100. The reflective flag 300 enhances the visibility of the hazard marker 100 thereby increasing its effectiveness. As shown, the flag 300 incorporates a threaded, brass fitting 305 at one end thereof. The brass fitting 305 screws into a threaded opening 315 incorporated in and through a top surface 325 of peg 310. A resilient wire (e.g., piano wire-not shown) runs internally along the length of the flag pole 335 causing the flag 300 to return to a vertical orientation after being displaced by an external force. The flag 300 can also be held in place with a clip, lock or similar means.

The peg 310 also acts to hold the lower section 120 and upper section 130 together. An extension member 345 threaded at one end 350 inserts through an opening 360 in the upper section 130 and a bore channel 370 through elevated member 375 in the lower section 120 such that the threaded end 350, or at least a portion thereof, protrudes through an underside of the lower section 120. A threaded wing nut 320 or similar connector securely fixes the peg 310 such that a peg platform 380 retains the upper section 130 against the lower section 120. Unscrewing the wing nut 320 allows the peg 310 to be removed and the lower section 120 and upper section 130 to be separated. By separating the lower and upper sections 120, 130 a user may change the batteries 145 or conduct maintenance on the hazard marker 100.

Optionally a magnet (not shown) may be fixed to an underside of the hazard marker 100 so that the hazard marker 100 may be attached to a car or other metallic object. This allows the user to more readily identify a stranded vehicle and to ensure that the hazard marker 100 remains in a static position.

Moreover, it should be understood that the hazard marker 100 may be used for purposes other than providing warning of a roadway incident. Other uses include identifying individuals as they walk, ride bicycles or participate in other potentially dangerous activities. In such an instance, individuals wear the hazard marker 100 on a belt or in a similar manner thereby allowing vehicular traffic to observe the illumination devices and therefore the wearer. The hazard markers 100 are also ideal for identifying barriers (e.g., construction sites) and landing zones for airplanes and helicopters.

Although the invention has been described in detail with reference to several embodiments, additional variations and modifications exist within the scope and spirit of the invention as described and defined in the following claims.

We claim:

1. A mobile hazard marker comprising:
a housing having a transparent section;
a series of illumination devices for creating a pre-established light pattern wherein said light pattern is visible through said transparent section;
a motion detector operable to alert users that the hazard marker has been moved in a pre-established manner; and
a transmitter in communication with said motion detector and operable to transmit a signal in response to the hazard marker being moved in the pre-established manner.

2. The hazard marker of claim 1 wherein the hazard marker is circular in shape.

3. The hazard marker of claim 1 further comprising means for retaining a reflective flag.

4. The hazard marker of claim 1 wherein the pre-established manner is thirty degrees off horizontal.

5. The hazard marker of claim 1 wherein the signal triggers an audible alarm.

6. The hazard marker of claim 1 further comprising a magnet for attaching the hazard marker to a metallic surface.

7. The hazard marker of claim 1 further comprising one or more solar panels for generating power.

8. A mobile hazard marker system comprising:
a housing having a transparent section;
a series of illumination devices for creating a pre-established light pattern wherein said light pattern is visible through said transparent section;
a motion detector operable to alert users that the hazard marker has been moved in a pre-established manner;
a transmitter in communication with said motion detector and operable to transmit a signal in response to the hazard marker being moved in the pre-established manner; and
one or more receivers for receiving the transmitted signal.

9. The hazard marker system of claim 8 wherein the hazard marker is circular in shape.

10. The hazard marker system of claim 8 wherein the hazard marker further comprises means for retaining a reflective flag.

11. The hazard marker system of claim 8 wherein the pre-established manner is thirty degrees off horizontal.

12. The hazard marker system of claim 8 wherein the receiver further comprises a speaker for generating an audible alarm in response to receiving the signal.

13. The hazard marker system of claim 8 wherein the one or more receivers are hand-held devices.

14. The hazard marker system of claim 8 further comprising a magnet for attaching the hazard marker to a metallic surface.

15. The hazard marker system of claim 8 further comprising one or more solar panels incorporated on said hazard marker for generating power.

16. A method of providing a safety warning comprising:
generating a light pattern visible through a hazard marker housing;
generating a signal in response to the hazard market housing being moved in a pre-established manner; and
sending said signal to a receiver to alert a user that the hazard marker has been moved in the pre-established manner.

17. The method of claim 16 further comprising generating an audible alarm in response to the receiver receiving the signal.

18. The method of claim 16 further comprising attaching the hazard marker to a metallic surface by means of a magnet.

19. The method of claim 16 further comprising utilizing solar power to generate at least a portion of required system power.
